(19) United States
(12) Patent Application Publication
(10) Pub. No.: US 2006/0199899 A1
(43) Pub. Date: Sep. 7, 2006

(54) Use of beads of cationic polymers in cosmetic compositions and cosmetic compositions thus obtained

(76) Inventors: Pierre Lyot, Saint-Etienne (FR); Eric Philibert, La Talaudiere (FR)

Correspondence Address: GREENBLUM & BERNSTEIN, P.L.C., 1950 ROLAND CLARKE PLACE, RESTON, VA, 20191, US

(21) Appl. No.: 10/551,240

(22) PCT Filed: Mar. 23, 2004
(86) PCT No.: PCT/FR04/00715

§ 371 Date: Sep. 28, 2005

(30) Foreign Application Priority Data
Mar. 31, 2003 (FR) 03/03949

(51) Int. Cl. C08F 8/30

(52) U.S. Cl. 524/555

(57) ABSTRACT

The invention relates to a cosmetic, dermatological, pharmaceutical, veterinary, or detergent composition comprising at least one conditioning cationic copolymer of diallyl dimethyl ammonium chloride (also called DADMAC) and acrylamide, obtained by polymerisation in inverse suspension. The polymer has a ratio (effective ionic character/theoretical ionic character) greater than 50% and a viscosity greater than 1000 cP (mpa·s) at a concentration of 8% at 25° C. and, in a surprising manne conditioning characteristics significantly better than those observed for the same product as available in other physical forms. The above is of use as a conditioning and film-forming agent for cationic copolymers made from DADMAC and acrylamide in the form of beads (also called pearls), produced by the technique of inverse suspension polymerisation.

### FIELD OF THE INVENTION

The present invention relates to the technical field of cosmetic, dermatological, pharmaceutical, veterinary, and detergent compositions, having at least one water-soluble conditioning cationic polymer.

The conditioning effect of a polymer is characterized by one with ordinary skill in the art when its use in formulations aims at and results in promoting ease of combing and/or providing smoothness and sheen, and/or increasing the static effect reduction.

### PRIOR ART

Cationic polymers have been known and used for a number of years in capillary products for their conditioning, film-forming and sheathing effects. One of the earliest commercially available cationic polymers is Polyquaternium 7, an acrylamide/DADMAC copolymer in aqueous solution. This ingredient is known for its efficiency and cost-effectiveness (good cost/performance ratio). Polyquaternium 7 now has all of the characteristics of a convenience product (bulk availability, low cost, plethora of suppliers).

In its reference standard form, Polyquaternium 7 is sold in a solution with low concentration of active matter (8-10%). More concentrated forms are also commercially available, including liquids with a higher concentration of about 40% (Patent Publication WO 02/40622, for example) and powders, but have not been successful enough to supplant the standard form (which represents more than 80, even 90% of the market share), since their performance (efficiency, use concentration, cost, etc.) does not give complete satisfaction to formulators.

Similarly, processes of synthesis of polymers in bead form by inverse suspension polymerization from water-soluble, ethylenically unsaturated monomers have been known since the late fifties. The techniques used as well as the necessary stabilizing kinds have been described in a number of patents, including, for example, DE 1110869 from 1959, U.S. Pat. No. 2,982,749 from 1961, FR 2383200 from 1977, U.S. Pat. No. 4,164,613 from 1977, and FR 23606612 from 1977. More particularly, production of polymers and copolymers in solid form based on salts of diallyl dialkyl ammonium, such as DADMAC, has been suggested or disclosed in U.S. Pat. No. 4,158,726, EP 233014, EP 495312, DE 3709921, and U.S. Pat. No. 4,833,198 Patents.

This polymerization method is however very expensive compared to the standard method used. In particular, it requires 4 industrial steps (polymerization, distillation, liquid/solid separation, drying) instead of a single step necessary for obtaining a liquid polymer. It can also cause very substantial product losses, especially during caking or formation of aggregates of polymer gels.

Business acumen requires first taking into account the functional advantage and commercial viability of a new product prior to its development. Therefore, proposing a product such as Polyquaternium 7 in bead form, which offers at best an efficiency similar to existing products but also involves higher costs, was not an option.

Moreover, there was no reason to believe that a suspension polymerization method would enable Polyquaternium 7 to conserve, and more particularly to improve its final characteristics obtained by liquid polymerization (as is explained in the Patent Publication WO 02/40622).

Quite logically, therefore, no one to date had yet sought to develop Polyquaternium 7 in bead form, since the efficiency thereof, let alone the competitiveness and durability of the offer, could not be anticipated.

### THE TECHNICAL PROBLEM

One of the merits of the invention lies in looking for a solution in this direction, in spite of the prospects of failure, and in seeking applications to Polyquaternium 7 in bead form, without drawbacks, and in a manner that is applicable industrywide.

For example, liquid products having a concentration of about 30%-40% are obtained from the Patent Publication WO 02/40622, but at the cost of a reduction in the molecular weight, without which the product can no longer be pumped.

### SUMMARY OF THE INVENTION

Surprisingly, it has been found, according to the invention, that polymerization of Polyquaternium 7 in bead form makes the polymer much more efficient than the liquid form, thus justifying its technical and commercial advantages.

The invention relates to the use of bead-formed copolymers based on acrylamide and DADMAC (diallyl dimethyl ammonium chloride) as a conditioning agent in cosmetic, dermatological, pharmaceutical, veterinary, or detergent compositions, as well as to the cosmetic, dermatological, pharmaceutical, veterinary, or detergent compositions containing at least one of these polymers as conditioner(s).

The invention aims more particularly at the field of cosmetics, in which the bead-formed polymer considered yields remarkable results.

The compositions of the invention are characterized in that they include as conditioning agents at least one polymer from the Polyquaternium 7 family (copolymers of acrylamide and DADMAC), characterized in that it is obtained by inverse suspension polymerization:
5-95 mole % diallyl dimethyl ammonium chloride (DADMAC); and
5-95 mole % acrylamide.

According to a preferred embodiment, the copolymer is obtained by inverse suspension polymerization based on:
10-40 mole % diallyl dimethyl ammonium chloride (DADMAC); and
60-90 mole % acrylamide.

During the inverse suspension polymerization (water-in-oil), the continuous phase used can be oil or a solvent of mineral origin, synthetic origin, or plant origin.

The resulting polymer has a ratio (effective ionic character/theoretical ionic character) greater than 50%, preferably greater. than 65%, and a Brookfield viscosity, measured on a polymer solution at a concentration of 8% by weight, greater than 1000 cP (mPa·s) at 25° Celsius (LVT module).

The polymerization is carried out in the presence of a transfer agent. Below is a non-limiting list of transfer agents: isopropylic alcohol, sodium hypophosphite, mercaptoethanol, etc.

Conventionally, the polymerization initiator can be either of the azoic or similar type (i.e., resulting from thermal degradation), or of the oxidoreducing type. It can also be a combination of these two types of primers.

The one with ordinary skill in the art will select the best combination based on his own knowledge and the present description, as well as on the examples that follow.

### EXAMPLES

1/The Polymers

The “standard” Polyquaternium 7 is an acrylamide/DADMAC copolymer obtained by solution polymerization and sold in a form having a low concentration of active matter (8-10%).

P polymers have been prepared according to the inverse suspension polymerization technique as described in U.S. Pat. No. 4,158,726.

The polymerization conditions for these 4 tests (referred to as P1, P2, P3, and P4) are strictly identical, with the use of known primer(s), such as t-butyl hydroperoxide (TBHP), and/or 2,2′-azobis [N-(2-hydroxyethyl)-2-methylpropionamidine)]dihydrochloride (V50), and/or ammonium persulfate (APS), consistent with U.S. Pat. No. 4,158,726.

The active matter content in the suspension can be in the range between 5 and 60%; however, the tests were conducted using a formulation having 30% of active matter.

The aqueous phase:

A chelating agent (EDTA (ethylene diamine tetraacetic), Versenex 80) is added to the aqueous phase, the pH of which is adjusted between 5.5 and 6.5.

The hydrophobic phase:

The dispersion medium is a hydrophobic liquid that is insoluble in the aqueous phase. For ecological and toxicological reasons, the tests use an aliphatic hydrocarbon forming an azeotrope with water.

The dispersion stabilizer:

Most of the known stabilizers of inverse suspensions (for examples those described in U.S. Pat. No. 2,982,749, U.S. Pat. No. 4,158,726, GB 1482515, and GB1329062 Patents) can be used without any significant interference with the results observed. The stabilizing agent used can be selected without discrimination from the following non-exhaustive list:
surfactants commonly used for water-in-oil emulsifications, preferably having an HLB comprised between 3 and 8, such as cellulose ether, sodium hexadecyl phthalate, sodium cetyl stearyl phthalate, sorbitan monooleate, sorbitan monostearate;
solid inorganic compounds such as silica, kaolin, or modified bentonite;
copolymers of hydrophilic (vinyl pyridines, aminoalkyl ester, aminoalkyl amide, acrylic acid, methacrylic acid, vinyl pyrrolidone, etc.) and hydrophobic (acrylic or methacrylic acid esters, etc.) monomers;
copolymers, the polar or nonpolar portions of which were capable of being included by grafting.

Prior to polymerization, the stabilizer (or mixture of stabilizers) is added to the hydrophobic phase. This phase is then degassed for 30 minutes in nitrogen under agitation (200 rpm). Next, the aqueous phase is dispersed, and then polymerized.

At the end of polymerization, the beads are separated from the hydrophobic phase by filtration on a sieve, with or without a preliminary dehydration step. The beads are then cleaned from their residues from the hydrophobic phase in a final drying step.

The resulting beads are spherical, with a diameter between 50 μm and 1000 μm, with a distribution conventionally centered on 350 μm.

An optimization of the polymerization conditions will be accessible to the one with ordinary skill in the art depending upon his personal knowledge, or by means of simple routine tests. Thus, he will be capable of varying the apportioning of primer(s) and/or transfer agents and the addition of possible additives.

2/The Study

The object of this study is to show the detangling effect of each product tested.

Evaluation Criteria

Detangling effect measured by means of a dynamometer (INSTRON®)

Measuring Principle(s) and Device(s)

The dynamometer (INSTRON® 1026) makes it possible to measure forces applied to various materials such as, in this case, the styling resisting force on locks of hair.

The hair lock is fixed vertically, between the two jaws of the force sensor located on the crossbeam and passes through the comb, which is itself fixed on the lower clamp.

The crossbeam then moves away from the stationary clamp at a constant speed of 4 cm/min.

Conducting the Test

Six series of 10 locks of approximately 10 grams are obtained:
locks washed with distilled water,
locks washed with each product to be tested, then rinsed off with distilled water, or 5 series of locks.

The treated locks are immersed for 3 minutes in the product in solution at a 0.3% concentration of active matter, and then rinsed off for about 20 seconds in the distilled water.

The tensile strength is measured on a wet lock.

Product(s) tested

| | | | Ratio |
|---|---|---|---|
| | Type | Theoretical | (effective ionic |
| | (Liquid (L), or | Ionic | character/theoretical |
| References | Beads (B)) | character | ionic character) |
| Standard | L | 30 | <50% |
| Polyquaternium 7 | | | |
| (*) | | | |
| P1 | B | 30 | 70% |
| P2 | B | 30 | 69% |
| P3 | B | 25 | 73% |
| P4 | B | 15 | 76% |

(*) products in liquid form (<15% of active matter) and sold, among other things, under the trademarks Flocare ™ C107, Salcare ™ SC10, Merquat ™ 550, Merquat ™ S, Conditioner P7 ™, etc.

Aspect(s)

Standard Polyquaternium: colorless aqueous solution,

P1, P2, P3, and P4—colorless beads.

Dosage

Each product tested is diluted at a concentration of 0.3% of active matter in distilled water.

Area(s) and Method(s) of Application

Area of application: lock of hair.

Method of application: by immersion of the lock in the solution.

Test Follow-Up

The ambient conditions during dosages were consistent with the provisions of the protocol:
Temperature: 22±2° C.
Relative humidity between 40% and 60%.

3/Results

Two parameters are measured: the styling resisting force (F expressed in Newton) and the distance over which this force is applied (I expressed in m).

The greater the styling resisting force, the larger the knots.

The longer lasting this styling resisting force, the more resistant the knots.

These two parameters make it possible to calculate the work W expressed in N.m according to the following formula:
W=F×I

The detangling effect can be calculated according to the following formula:
E%=((Wt−Wprt)/Wt)×100

Where: Wt=work of specimen locks
Wprt=work of treated locks

The table below shows the individual values and the mean values (n=10) of the work W (in N.m) calculated for the various series, as well as the minimum, maximum and SEM.

The detangling effect in % is also calculated.

| | | standard | | | | |
|---|---|---|---|---|---|---|
| | | PQN 7 | | | | |
| Lock No. | Specimen | (+) | P1 | P2 | P4 | P3 |
| 1 | VA | 1.08 | 0.00 | 0.00 | 0.00 | 0.00 |
| 2 | 2.61 | 1.14 | 0.00 | 0.33 | 0.00 | 0.00 |
| 3 | 7.55 | 0.80 | 0.00 | 0.00 | 0.00 | 0.42 |
| 4 | 2.42 | 1.39 | 0.00 | 0.00 | 0.00 | 0.00 |
| 5 | 5.16 | 0.33 | 0.00 | 0.00 | 0.00 | 0.48 |
| 6 | 3.10 | 0.10 | 0.00 | 0.00 | 0.00 | 0.00 |
| 7 | 3.17 | 0.00 | 0.00 | 0.00 | 0.46 | 0.00 |
| 8 | 4.90 | 0.29 | 0.00 | 0.00 | 0.52 | 0.29 |
| 9 | 2.66 | 1.49 | 0.74 | 0.53 | 0.00 | 0.00 |
| 10 | 3.53 | 0.98 | 0.00 | 0.00 | 0.69 | 0.16 |
| Mean | 3.90 | 0.76 | 0.07 | 0.09 | 0.17 | 0.14 |
| Median | 3.2 | 0.9 | 0.0 | 0.0 | 0.0 | 0.0 |
| Minimum | 2.4 | 0.0 | 0.0 | 0.0 | 0.0 | 0.0 |
| Maximum | 7.5 | 1.5 | 0.7 | 0.5 | 0.7 | 0.5 |
| SEM | 0.6 | 0.2 | 0.1 | 0.1 | 0.1 | 0.1 |
| IC 95% | 1.3 | 0.4 | 0.2 | 0.1 | 0.2 | 0.1 |
| Detangling | | 80.5 | 98.1 | 97.8 | 95.7 | 96.5 |
| effect in % | | | | | | |

(+) Standard Polyquaternium 7

Conclusions

Under the conditions of this study, we can classify the products from least-to-most detangling in relation to the Control distilled water:
Standard Polyquaternium 7 (80.5% of detangling effect).
P4 and P3, equivalent detangling effect (95.7% and 96.5%, respectively).
P1 and P2, equivalent detangling effect (98.1% and 97.8% of detangling effect).

It is noted that an inverse suspension polymerization surprisingly provides a level of performance that is significantly higher than the standard Polyquaternium 7.

4/Final Compositions—Applications

Due to their physical properties, the polymers of the invention are advantageous ingredients for any compositions requiring conditioning and/or film-forming properties.

Possible galenical forms for the cosmetic, pharmaceutical, dermatological or veterinary compositions are numerous: aqueous solution, gel, anhydrous form ready for use, O/W or W/O emulsion. They are not restrictive with respect to the choice of the packaging selected (tube, spray, jar, etc.). They are incorporated in compositions for topical and/or capillary applications.

Below are several non-exhaustive examples of bases in which the polymers of the invention can be envisioned.

| | |
|---|---|
| Shower gel base: | |
| Ammonium lauryl sulphate | 4% |
| Cocamidopropyl betaine | 1.5% |
| Cocamide DEA | 1.5% |
| Polymer P3 | 0.3% |
| Water | QSP 100% |
| Transparent base for a conditioning shampoo: | |
| sodium laureth sulphate | 10% |
| Cocamidopropyl betaine | 2% |
| Cocamide DEA | 1.5% |
| Polymer P3 | 0.3% |
| Sodium Chloride | QS |
| Water | QSP 100% |
| Base for an after-shampoo cream: | |
| Olive (Olea europaea) Oil | 1% |
| Caprylic/Capric Triglyceride | 2% |
| Ethylhexyl Stearate | 2% |
| FLOCARE ET75 | 2% |
| Polymer P2 | 0.3% |
| Water | QSP 100 |

The Applicant has also noted that use of the polymers of the invention in concentrated or non-concentrated detergent or softening compositions based on surfactants or softening agents makes it possible to substantially improve the intrinsic properties of the final composition, while increasing its stability.

In addition to the various advantages aforementioned advantages, the polymers of the invention, which are dried stored, have better stability and conservation, as well as lower transportation cost.

The invention also encompasses all of the embodiments and applications that will be directly accessible to the one with ordinary skill in the art upon reading the present application, from his own knowledge, and possibly from simple routine tests.

1-8. (canceled)

9. A conditioning method comprising applying a conditioning composition comprising at least one polymer obtained by inverse suspension polymerization based on:
10-40 mole % diallyl dimethyl ammonium chloride (DADMAC); and
60-90 mole % acrylamide.

10. The method of claim 9, wherein the conditioning composition comprises at least one of a cosmetic, dermatological, pharmaceutical, veterinary, or detergent composition.

11. The method of claim 9, wherein the at least one polymer is obtained by inverse suspension polymerization based on:
10-40 mole % diallyl dimethyl ammonium chloride (DADMAC); and
60-90 mole % acrylamide.

12. The method of claim 9, wherein the at least one polymer is in bead form.

13. The method of claim 9, wherein the at least one polymer has a ratio (effective ionic character/theoretical ionic character) greater than 50%.

14. The method of claim 13, wherein the at least one polymer has a ratio (effective ionic character/theoretical ionic character) greater than 65%.

15. The method of claim 9, wherein the at least one polymer has a Brookfield viscosity, measured on an LVT module on a polymer solution at a concentration of 8% by weight, greater than 1000 cP (mPa·s) at 25° Celsius.

16. The method of claim 9, wherein the polymerization is carried out in the presence of a transfer agent.

17. The method of claim 9, wherein the at least one polymer has a detangling effect greater than 85%.

18. The method of claim 17, wherein the at least one polymer has a detangling effect greater than 90%.

19. A conditioning composition comprising at least one polymer obtained by inverse suspension polymerization of:
5-95 mole % diallyl dimethyl ammonium chloride (DADMAC); and
5-95 mole % acrylamide.

20. The conditioning composition of claim 19, wherein the composition comprises at least one of a cosmetic, dermatological, pharmaceutical, veterinary, or detergent composition.

21. The conditioning composition of claim 19, wherein the at least one polymer is obtained by inverse suspension polymerization based on:
10-40 mole % diallyl dimethyl ammonium chloride (DADMAC); and
60-90 mole % acrylamide.

22. The conditioning composition of claim 19, wherein the at least one polymer is in bead form.

23. The conditioning composition of claim 19, wherein the at least one polymer has a ratio (effective ionic character/theoretical ionic character) greater than 50%.

24. The conditioning composition of claim 23, wherein the at least one polymer has a ratio (effective ionic character/theoretical ionic character) greater than 65%.

25. The conditioning composition of claim 19, wherein the at least one polymer has a Brookfield viscosity, measured on an LVT module on a polymer solution at a concentration of 8% by weight, greater than 1000 cP (mPa·s) at 250 Celsius.

26. The conditioning composition of claim 19, wherein the polymerization is carried out in the presence of a transfer agent.

27. The conditioning composition of claim 19, wherein the at least one polymer has a detangling effect greater than 85%.

28. The conditioning composition of claim 27, wherein the at least one polymer has a detangling effect greater than 90%.
